(19) United States
(12) Patent Application Publication
(10) Pub. No.: US 2012/0055163 A1
(43) Pub. Date: Mar. 8, 2012

(54) FUEL INJECTION ASSEMBLY FOR USE IN TURBINE ENGINES AND METHOD OF ASSEMBLING SAME

(76) Inventors: Jong Ho Uhm, Simpsonville, SC (US); Thomas Edward Johnson, Greer, SC (US)

(21) Appl. No.: 12/877,161

(22) Filed: Sep. 8, 2010

(51) Int. Cl. F02C 7/22; B23P 19/00

(52) U.S. Cl. 60/742; 29/700

(57) ABSTRACT

A method for assembling a fuel injection assembly for use in a turbine engine is provided. The method includes providing at least one cap member that has at least one first opening extending at least partially through it and at least one second opening extending at least partially through it. The method includes coupling a plurality of tube assemblies within the turbine engine. Each tube assembly includes a plurality of tubes. Moreover, the method includes coupling an injection system to the cap member to enable a fluid from a fluid source to be discharged through the at least one second opening. This fluid provides a barrier between adjacent tube assemblies to facilitate reducing dynamic pressure oscillations within the fuel injection assembly during turbine engine operation.

### FEDERAL RESEARCH STATEMENT

This invention was made with Government support under Contract No. DE-FC26-05NT42643, awarded by the Department of Energy (DOE), and the Government has certain rights in this invention.

### BACKGROUND OF THE INVENTION

The subject matter disclosed herein generally relates to turbine engines and, more particularly, to a fuel injection assembly for use in a turbine engine.

At least some known turbine engines are used in cogeneration facilities and power plants. Such engines may have high specific work and power per unit mass flow requirements. To facilitate increasing the operating efficiency, at least some of known turbine engines, such as gas turbine engines, operate with increased combustion temperatures. In known gas turbine engines, engine efficiency increases as combustion gas temperatures increase.

However, operating with higher temperatures may also increase levels of polluting emissions, such as oxides of nitrogen (NO_{X}). In an attempt to reduce the generation of such emissions, at least some known engines include improved combustion system designs. More specifically, at least some of such known combustion systems operate with increased dynamic pressure oscillations. Such dynamic pressure oscillations may increase the noise generated by the combustion system, may increase the wear of the combustor, and/or may shorten the useful life of the combustion system.

Although multi-fuel combustion assemblies generally operate with reduced noise, such combustion systems may provide only limited performance results. For example, such systems may operate with high hydrogen gas levels that can induce a screech tone frequency level of greater than 1 kHz. Such a screech frequency range may result in a flame behavior that appears as a coupling interaction between the nozzles within the combustion assembly. Moreover, such interaction may also induce vibration energy through the combustion assembly and associated hardware components.

### BRIEF DESCRIPTION OF THE INVENTION

In one embodiment, a method for assembling a fuel injection assembly for use in a turbine engine is provided. The method includes providing at least one cap member that has at least one first opening extending at least partially through it and a plurality of second openings extending at least partially through it. The method includes coupling a plurality of tube assemblies within the turbine engine. Each tube assembly includes a plurality of tubes. Moreover, the method includes coupling at least one injection system to the cap member to enable a fluid from a fluid source to be discharged through at least one of the plurality of second openings. The fluid provides a barrier between adjacent tube assemblies to facilitate reducing dynamic pressure oscillations in a combustor during turbine engine operation.

In another embodiment, a fuel injection assembly for use in a turbine engine is provided. The fuel injection assembly includes a cap member having at least one first opening extending at least partially through it and a plurality of second openings extending at least partially through it. The fuel injection assembly also includes a plurality of tube assemblies having a plurality of tubes. Each of the plurality of tube assemblies are aligned substantially within the cap member. The fuel injection assembly also includes at least one injection system having a fluid supply member coupled in flow communication between a fluid source and the cap member. The injection system is configured to discharge fluid through at least one of the plurality of second openings in order to provide a barrier between tube assemblies to facilitate reducing dynamic pressure oscillations in a combustor during turbine engine operation.

In another embodiment, a turbine engine is provided. The turbine engine includes a compressor and a combustion assembly coupled downstream from the compressor. The combustion assembly includes at least one combustor that includes at least one fuel injection assembly. The fuel injection assembly has a cap member, a plurality of tube assemblies, and at least one injection system. The cap member includes at least one first opening extending partially through it and a plurality of second openings extending at least partially through it. Each tube assembly is aligned substantially within the cap member and includes a plurality of tubes. The injection system is coupled in flow communication to the cap member for discharging fluid through at least one of the plurality of second openings in order to provide a barrier between tube assemblies to facilitate reducing dynamic pressure oscillations in the combustor during turbine engine operation.

### BRIEF DESCRIPTION OF THE DRAWINGS

FIG. 1 is a cross-sectional view of an exemplary known gas turbine engine;

FIG. 2 is a cross-sectional view of a portion of a fuel injection assembly that may be used with the gas turbine engine shown in FIG. 1 and taken along area 2;

FIG. 3 is an enlarged cross-sectional view of a portion of an injection system that may be used with the fuel injection assembly shown in FIG. 2 and taken along area 3;

FIG. 4 is an upstream view of a portion of the fuel injection assembly shown in FIG. 2 and taken along line 4-4;

FIG. 5 is a downstream view of a portion of the fuel injection assembly shown in FIG. 2 and taken along line 5-5; and

FIG. 6 is a flow chart illustrating an exemplary method of assembling the fuel injection assembly shown in FIG. 2.

### DETAILED DESCRIPTION OF THE INVENTION

The exemplary methods, apparatus, and systems described herein overcome disadvantages associated with known combustion systems that may operate with vibration energy induced therein and within its associated hardware components. Specifically, the embodiments described herein provide a combustion assembly that operates with reduced dynamic pressure oscillations by utilizing a fuel injection assembly that acts as a sound baffle and breaks a flame interaction between a center fuel injection nozzle and at least one outer fuel injection nozzle in the fuel injection assembly. More specifically, the embodiments described herein enable a fluid source to be injected into a combustion chamber such that the fluid source is aligned adjacent to a center fuel injection nozzle breaking coupling interaction between a center fuel injection nozzle and at least one outer fuel injection nozzle in the fuel injection assembly. Therefore, the fluid provides a barrier between adjacent nozzles to facilitate reducing dynamic pressure oscillations.

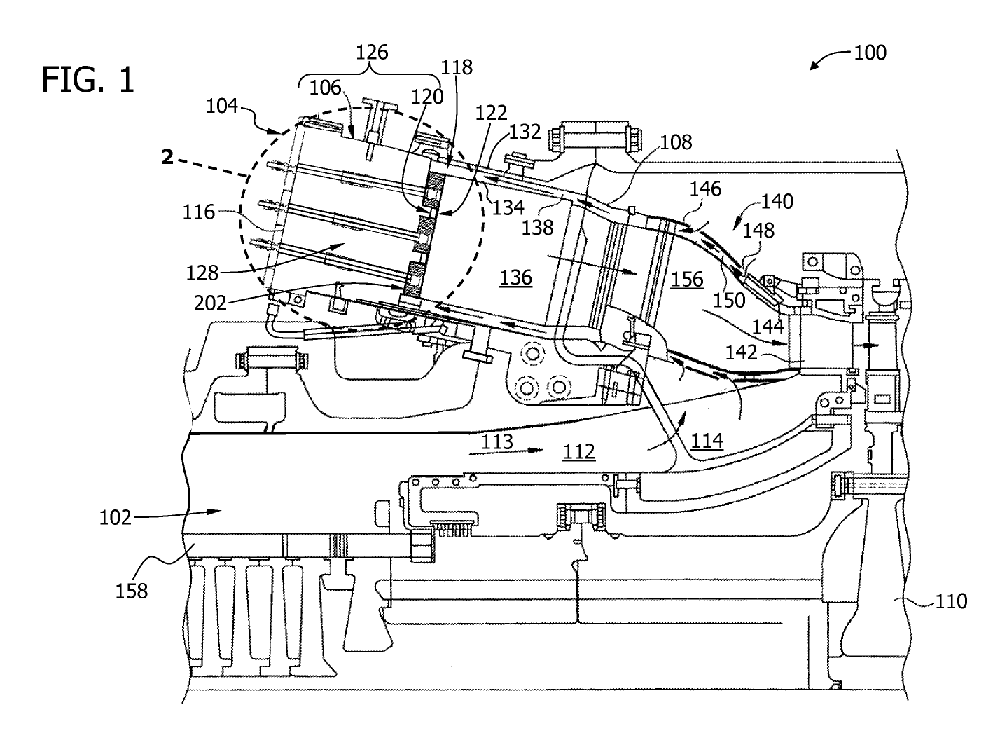

FIG. 1 illustrates a cross-sectional view of an exemplary known gas turbine engine 100. While the exemplary embodiment includes a gas turbine engine 100, the present invention is not limited to any one particular engine, and one of ordinary skill in the art will appreciate that the current invention may be used in connection with other turbine engines.

In the exemplary embodiment, gas turbine engine 100 includes a compressor 102 and a combustor assembly 104 that includes at least one combustor 106. Each combustor 106 includes at least one fuel injection assembly housing 108 that houses a fuel injector therein. Gas turbine engine 100 includes a turbine 110 and a drive shaft 158. Combustor 106 is coupled in flow communication with compressor 102 and turbine 110. Compressor 102 includes a diffuser 112 and a compressor discharge plenum 114 that are coupled in flow communication with each other.

In an exemplary embodiment, combustor 106 includes an end cover 116, positioned at an end thereof, and at least one cap member 118. Cap member 118 includes an impingement plate 120 and an effusion plate 122. Impingement plate 120 is coupled to effusion plate 122 such that impingement plate 120 constitutes an upstream surface of cap member 118 and effusion plate 122 constitutes a downstream surface of cap member 118.

Cap member 118 is spaced a distance 126 from end cover 116 such that an interior flow path 128 is defined through combustor 106. Moreover, Combustor 106 also includes a combustor casing 132 and a combustor liner 134. Combustor liner 134 is positioned radially inward from combustor casing 132 such that a combustion chamber 136 is defined within combustor 106. An annular cooling passage 138 is defined between casing 132 and liner 134, and each extends from cap member 118 to a transition piece 140, which couples combustor 106 to turbine 110. Transition piece 140 channels combustion gases generated in combustion chamber 136 downstream towards a first stage turbine nozzle 142. Transition piece 140 includes an inner wall 144 and an outer wall 146. Outer wall 146 includes a plurality of openings 148 that are in fluid communication with an annular passage 150 defined between inner wall 144 and outer wall 146. Inner wall 144 defines a cavity 156 that extends from combustion chamber 136 to turbine nozzle 142.

During operation, air flows through compressor 102 and compressed air is supplied to combustor 106. Fuel is injected into the compressed air forming a combustible mixture. The combustible mixture is channeled downstream into combustion chamber 136 and ignited to form combustion gases that are discharged towards turbine 110. Thermal energy from the combustion gases is converted to mechanical rotational energy. The hot gases impacting first stage turbine nozzle 142 create a rotational force that ultimately produces work from turbine 110.

More specifically, turbine 110 drives compressor 102 via drive shaft 158. As compressor 102 rotates, compressed air is discharged into diffuser 112 as indicated by associated arrows 113. In an exemplary embodiment, the majority of air discharged from compressor 102 is channeled through compressor discharge plenum 114 towards combustor 106. Any remaining air discharged from compressor 102 is channeled for use in cooling engine components. More specifically, pressurized compressed air within discharge plenum 114 is channeled into transition piece 140. Air is then channeled from annular passage 150 to cap member 118. The fuel and air are mixed in at least one tube assembly 202, such as a fuel injection nozzle, to form a combustible mixture that is ignited to form combustion gases within combustion chamber 136. Combustor casing 132 facilitates shielding combustion chamber 136 and its associated combustion processes from the outside environment such as, for example, surrounding turbine components. Combustion gases are channeled from combustion chamber 136 through cavity 156 and towards turbine nozzle 142.

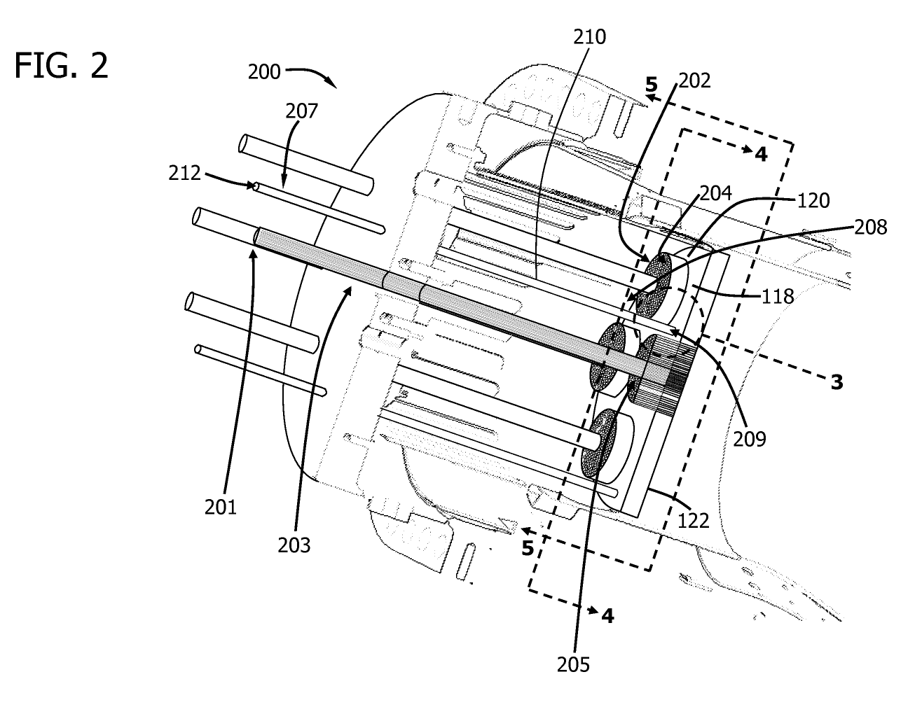

FIG. 2 is a cross-sectional view of a portion of a fuel injection assembly 200 used with gas turbine engine 100 and taken along area 2 (shown in FIG. 1). Fuel injection assembly 200 includes cap member 118. Cap member 118 includes impingement plate 120 and effusion plate 122. Moreover, fuel injection assembly 200 includes a plurality of tube assemblies 202, such as a plurality of fuel injection nozzles. Each tube assembly 202 is substantially aligned within the cap member 118 and includes a plurality of tubes 204. More specifically, in the exemplary embodiment, plurality of tube assemblies 202 are formed integrally with the cap member. Each tube 204 includes a mixture of fuel and air that flows through a passage in the tube.

Moreover, in the exemplary embodiment, each tube assembly 202 is coupled to a fuel delivery pipe 203. Fuel delivery pipe 203 includes a first end portion 201 and a second end portion 205. First end portion is coupled to a fuel source (not shown) and second end portion 205 is coupled to tube assembly 202.

Cap member 118 includes at least one first opening (not shown in FIG. 2) extending at least partially through cap member 118 and at least one second opening (not shown in FIG. 2) extending at least partially through cap member 118. Fuel injection assembly 200 also includes at least one injection system 208, which has a fluid supply member 210 coupled in flow communication between a fluid source 212 and cap member 118. More specifically, fluid supply member 210 has a first end portion 207 and a second end portion 209. First end portion 207 of fluid supply member 210 is coupled to fluid source 212 and second end portion 209 of fluid supply member 210 is coupled to cap member 118. Specifically, as discussed below, fluid supply member 210 is coupled to impingement plate 120.

In the exemplary embodiment, fluid supply member 210 has a substantially cylindrical shape defining a linear flow path. Alternatively, fluid supply member 210 may have various shapes defining various different flow paths that enable the fluid supply member 210 to fit appropriately within fuel injection assembly 200 and function as described herein.

Injection system 208 discharges fluid through the at least one second opening in order to provide a barrier between adjacent tube assemblies 202 to facilitate reducing dynamic pressure oscillations in a combustor 106 (shown in FIG. 1) during turbine engine operation.

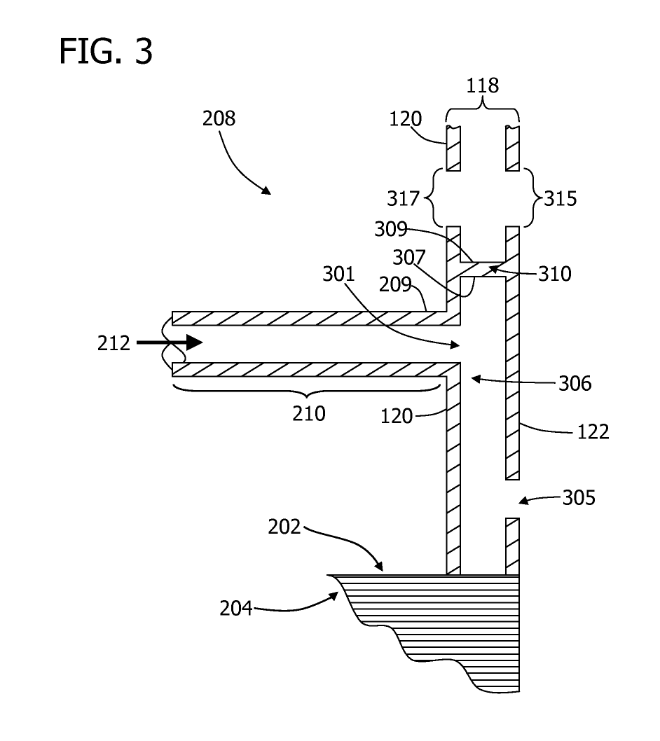

FIG. 3 is an enlarged cross-sectional view of a portion of injection system 208 and taken along area 3 (shown in FIG. 2). In the exemplary embodiment, injection system 208 includes a portion of cap member 118. Cap member 118 includes at least one first opening 301 extending partially through cap member 118. In the exemplary embodiment, cap member 118 also includes one of a plurality of second openings 305 that extends partially through cap member. More specifically, injection system 208 includes effusion plate 122 and impingement plate 120. Impingement plate 120 has the first opening 301 extending therethrough and effusion plate 122 has second opening 305 extending therethrough. In the exemplary embodiment, first opening 301 is spaced adjacent to at least one tube assembly 202. Second opening 305 is also spaced adjacent to at least one tube assembly 202. While not shown in FIG. 3, plurality of second openings 305 can be spaced circumferentially about at least one tube assembly 202. Moreover, in the exemplary embodiment, second opening 305 is defined downstream from first opening 301.

Moreover, injection system 208 includes fluid supply member 210 that is coupled to impingement plate 120. In the exemplary embodiment, second end portion 209 of fluid supply member 210 is inserted into opening 301 such that fluid can be discharged from fluid supply member 210 through impingement plate 120.

Impingement plate 120 is coupled to effusion plate 122 such that a channel 306 is defined therebetween. Channel 306 is oriented to direct fluid flow into second opening 305. Impingement plate 120 is also coupled upstream from effusion plate 122. Injection system 208 is configured to discharge fluid from fluid supply member 210 through opening 301 into channel 306. Fluid then flows through the at least one second opening 305.

Moreover, in the exemplary embodiment, injection system 208 includes a divider 310 positioned within channel 306, and between impingement plate 120 and effusion plate 122. Alternatively, divider 310 can extend through impingement plate 120 and spaced circumferentially about at least one tube assembly 202. Divider 310 is used to substantially separate air from the fluid flow. Divider 310 has a first surface 307 and a second surface 309. In the exemplary embodiment, a portion of effusion plate 122 that is located on the same side as the second surface 309 of divider 310 includes at least one opening 315. Similarly, a portion of impingement plate 120 that is located on the same side as the second surface 309 of divider 310 includes at least one opening 317. The effusion plate opening 315 and the impingement plate opening 317 are each designed to allow air to pass through. Various fluids can be used as the fluid source 212. For example, inert gases, such as nitrogen gas, carbon dioxide, and steam can be used. Such inert gases are used primarily in high momentum jets. Moreover, diluents, such as air can be used. Moreover, a combination of inert gases and diluents can be used. For example, nitrogen gas may be used with carbon dioxide. Alternatively, nitrogen gas may be used with air.

During operation, fuel is supplied to tube assemblies 202 and is mixed with air to form a combustible mixture. At the same time, fluid flow is supplied via injection system 208 to the at least one second opening 305. In the exemplary embodiment, fluid is channeled from fluid source 212 to first end portion 207 of fluid supply member 210. Fluid then flows through fluid supply member 210 and to the second end portion 209 of fluid supply member 210. Fluid then flows from the second end portion 209 of fluid supply member 210 the at least one first opening 301 and into channel 306. Fluid flows through the at least one second opening 305. At the same time, a portion of the fluid is channeled through divider 310 and air flow can separate from the fluid flow through impingement plate opening 317 and effusion plate opening 315.

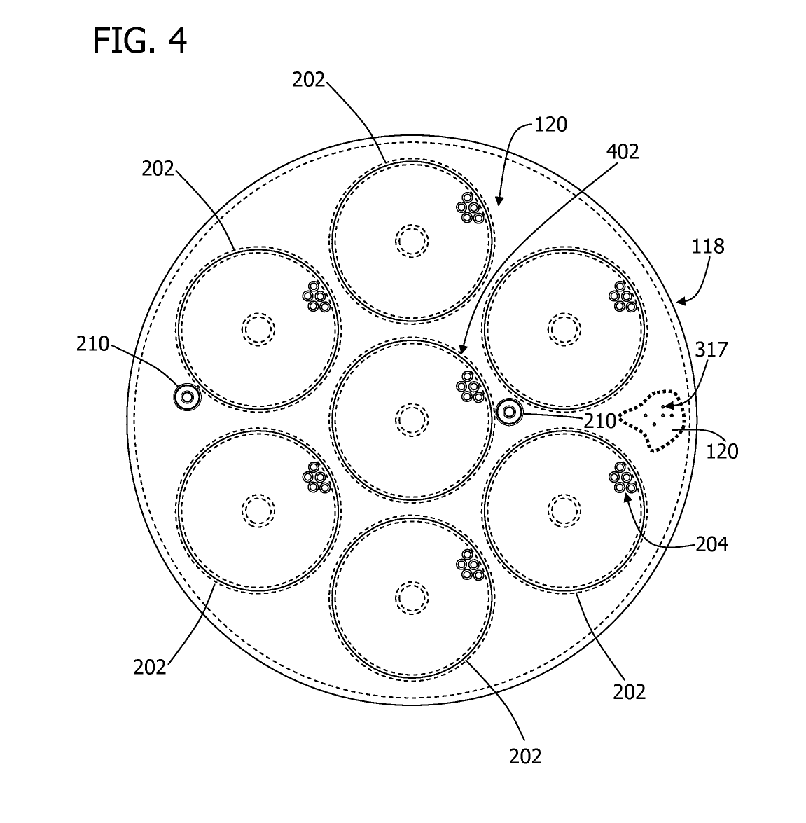

FIG. 4 is an upstream view of a portion of the fuel injection assembly 200 taken along line 4-4 (shown in FIG. 2). In the exemplary embodiment, tube assemblies 202 and a central tube assembly 402 are aligned substantially within the cap member 118. More specifically, tube assemblies 202 and 402 are integrally formed with the cap member.

In the exemplary embodiment, tube assemblies 202 are spaced circumferentially about central tube assembly 402 on the impingement plate 120. Alternatively, tube assemblies 202 may be oriented in any orientation that enables tube assemblies 202 to function as described herein. Moreover, fluid supply member 210 is positioned adjacent to central tube assembly 402 such that fluid supply member 210 is coupled in flow communication between fluid source 212 and cap member 118, allowing for fluid to be discharged into the at least one second opening 305.

Moreover, in the exemplary embodiment, each tube assembly 202 and 402 is shown as having five tubes 204. Alternatively, each tube assembly 202 and 402 can have any number of tubes 204 that enable each tube assembly 202 and 402 to function as described herein.

In the exemplary embodiment, fluid supply member 210 is spaced adjacent to central tube assembly 402 and another fluid supply member 210 is spaced adjacent to outer tube assembly 202. Alternatively, fluid supply members 210 may be oriented in any orientation that enables fluid supply members 210 to function as described herein. For example, each tube assembly 202 can have a fluid supply member 210 oriented adjacent to it such that a plurality of fluid supply members 210 can be oriented on cap member 118.

Impingement plate 120 includes plurality of openings 317 that are designed to allow air to pass through the impingement plate. In the exemplary embodiment, the plurality of openings 317 are shown in only one area of the impingement plate 120. Alternatively, the plurality of openings 317 may be located on the entire impingement plate 120, except for where the tube assemblies 202 and 402 are located.

In the exemplary embodiment, each fluid supply member 210 is coupled to the cap member 118 such that the fluid supply member 210 is positioned adjacent to tube assembly 202 in close proximity. Alternatively, a connecting device may be used so the fluid supply member 210 is coupled to the cap member and an adjacent tube assembly 202. For example, a manifold can be used to connect the fluid supply member 210 with an adjacent tube assembly 202. Moreover, a manifold may be designed and used to assemble a plurality of fluid supply members 210 around tube assemblies 202.

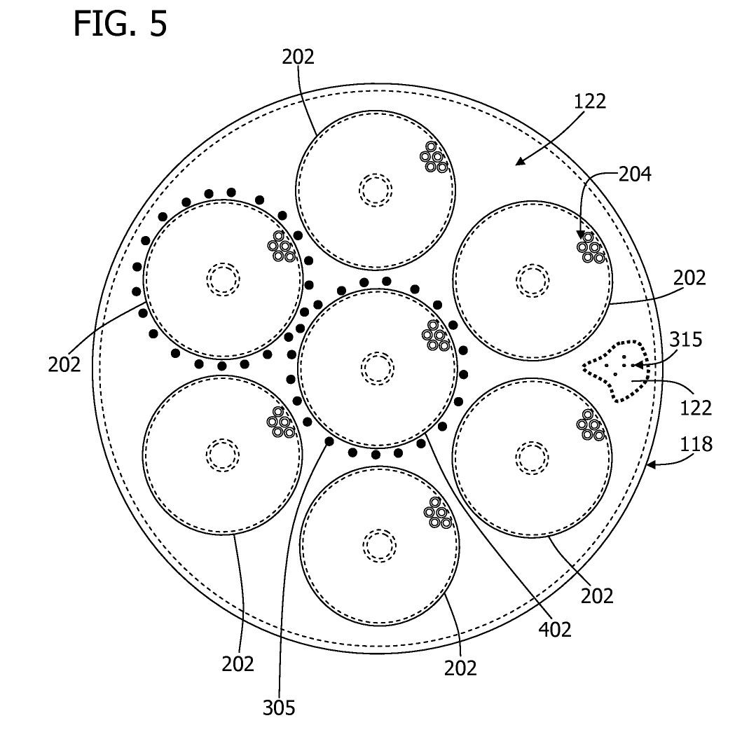

FIG. 5 is a downstream view of a portion of the fuel injection assembly 200 taken along line 5-5 (shown in FIG. 2). In the exemplary embodiment, tube assemblies 202 and central tube assembly 402 are aligned substantially within the cap member 118. More specifically, tube assemblies 202 and 402 are integrally formed with the cap member.

In the exemplary embodiment, the plurality of tube assemblies 202 and central tube assembly 402 are shown on effusion plate 122 of cap member 118. Moreover, in the exemplary embodiment, each tube assembly 202 is shown as having only five tubes 204. Alternatively, each tube assembly 202 can have any number of tubes 204 that enable each tube assembly to function as described herein.

In the exemplary embodiment, tube assemblies 202 are spaced circumferentially about central tube assembly 402 on the impingement plate 120. Alternatively, tube assemblies 202 may be oriented in any orientation that enables tube assemblies 202 to function as described herein.

In the exemplary embodiment, plurality of second openings 305 are spaced adjacent to at least one tube assembly 202. More specifically, plurality of second openings 305 are spaced circumferentially about at least one tube assembly 202. In the exemplary embodiment, plurality of second openings 305 are shown spaced circumferentially about the central tube assembly 402 and a plurality of second openings 305 are shown spaced circumferentially about an adjacent outer tube assembly 202. Moreover, effusion plate 122 includes plurality of openings 315 that are each designed to allow air to pass through the effusion plate. In the exemplary embodiment, the plurality of openings 315 are shown in only one area of the effusion plate 122. Alternatively, the plurality of openings 315 may be located on the entire effusion plate 122, except for where the tube assemblies 202 and 402 are located.

During operation, fluid flows through each second opening 305 and this fluid facilitates breaking or disrupting the coupling interaction between adjacent tube assemblies 202. In the exemplary embodiment, fluid is discharged through each second opening 305 about the central tube assembly 402 and an adjacent outer tube assembly 202. The fluid being discharged through each second opening 305 about the central tube assembly 402 prevents central tube assembly 402 from interacting with at least one of the circumferentially adjacent tube assemblies 202. More specifically, the fluid facilitates breaking or disrupting the coupling interaction between central tube assembly 402 and at least one of the circumferentially adjacent tube assembly 202. Similarly, fluid being discharged through each second opening 305 about outer tube assembly 202 prevents outer tube assembly 202 from interacting with at least one other adjacent tube assembly 202.

The fluid provides a barrier between adjacent tube assemblies to facilitate reducing dynamic pressure oscillations in a combustor 106 (shown in FIG. 1). More specifically, the fluid acts as a sound baffle for each tube assembly.

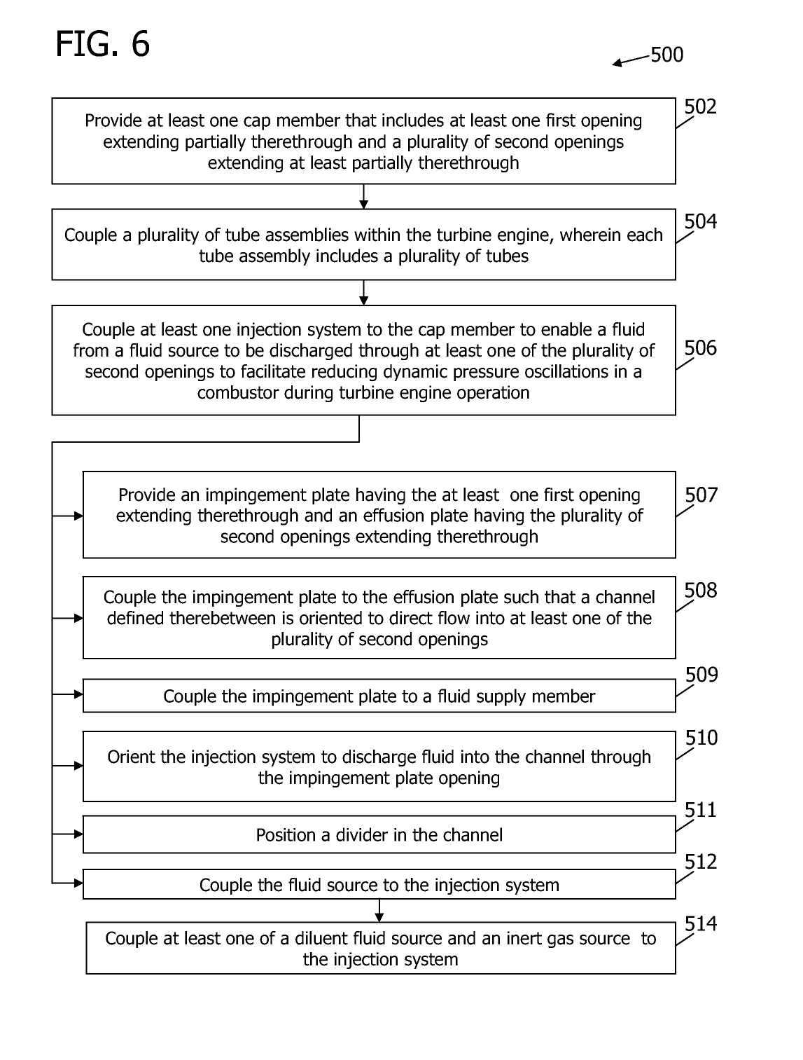

FIG. 6 is a flow chart illustrating an exemplary method 500 of assembling a fuel injection assembly, such as fuel injection assembly 200 (shown in FIG. 2) for use in a known gas turbine engine 100 (shown in FIG. 1). Initially, cap member 118 (shown in FIGS. 1, 2, 3, 4 and 5) having at least one first opening 301 extending at least partially therethrough (shown in FIG. 3) and a plurality of second openings 305 (shown in FIGS. 3 and 5) extending at least partially therethrough is provided 502. A plurality of tube assemblies 202 (shown in FIGS. 2 and 4) including a plurality of tubes 204 are coupled 504 within turbine engine 100 such that plurality of tube assemblies 202 are aligned substantially within cap member 118. At least one injection system 208 (shown in FIGS. 2 and 3) is then coupled 506 to cap member 118 to enable a fluid from a fluid source 212 (shown in FIGS. 2 and 3) to be discharged through at least of the one of the plurality of second openings 305. Discharging a fluid though opening 305 facilitates reducing dynamic pressure oscillations within fuel injection assembly 200 during turbine engine operation.

When injection system 208 is coupled 506 to cap member 118, an impingement plate 120 (shown in FIGS. 1, 2, 3 and 4) and an effusion plate 122 (shown in FIGS. 1, 2, 3 and 5) are provided 507. Impingement plate 120 has the at least one first opening 301 (shown in FIG. 3) extending therethrough and the at least one first opening 301 is spaced adjacent to at least one of the plurality of tube assemblies 202. Effusion plate 122 has the plurality of second openings 305 (shown in FIGS. 3 and 5) extending therethrough and the plurality of second opening 305 are spaced circumferentially about at least one of the plurality of tube assemblies 202. Moreover, impingement plate 120 is coupled 508 to effusion plate 122 (shown in FIG. 3) such that a channel 306 (shown in FIG. 3) defined therebetween is oriented to direct a fluid flow into at least one of the plurality of second openings 305.

As injection system 208 is coupled 506 to cap member 118, impingement plate 120 is coupled 509 to a fluid supply member 210 (shown in FIG. 2 and FIG. 3). Injection system 208 is then oriented 510 to discharge fluid into the channel 306 from fluid supply member 210 through the at least one first opening 301. Moreover, as injection system 208 is coupled 506 to cap member 118, a divider 310 (shown in FIG. 3) is positioned 511 in the channel to facilitate separating air from the fluid flow during turbine engine operation.

In the exemplary embodiment, as injection system 208 is coupled 506 to cap member 118, fluid source 212 is coupled 512 to injection system 208. Moreover, as fluid source 212 is coupled 512 to injection system 208, a diluent source or an inert gas source is coupled 514 to injection system 208. The inert gas source can include nitrogen gas, carbon dioxide and steam. The diluent source can include air.

The methods and apparatus described herein facilitate operation of turbine engines. More specifically, the fuel injection assembly described above facilitates a reduction in dynamic pressure oscillations during turbine engine operation. The fuel injection assembly includes at least one injection system that enables a fluid source to be injected into a combustion chamber such that the fluid source is aligned adjacent to a center fuel injection nozzle breaking any flame interaction, such as coupling, between a center fuel injection nozzle and at least one outer fuel injection nozzle in the fuel injection assembly and between adjacent outer fuel injection nozzles.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for assembling a fuel injection assembly for use with a turbine engine, said method comprising:
providing at least one cap member that includes at least one first opening extending at least partially therethrough and a plurality of second openings extending at least partially therethrough;
coupling a plurality of tube assemblies within the turbine engine, wherein each tube assembly includes a plurality of tubes; and
coupling at least one injection system to the at least one cap member to enable a fluid from a fluid source to be discharged through at least one of the plurality of second openings providing a barrier between adjacent tube assemblies to facilitate reducing dynamic pressure oscillations in a combustor during turbine engine operation.

2. A method in accordance with claim 1 further comprising:
providing the at least one cap member with an impingement plate, wherein the impingement plate has the at least one first opening extending therethrough, the at least one first opening is spaced adjacent to at least one of the plurality of tube assemblies;
providing the at least one cap member with an effusion plate, wherein the effusion plate has the plurality of second openings extending therethrough, the plurality of second openings are spaced circumferentially about at least one of the plurality of tube assemblies; and
coupling the impingement plate to the effusion plate such that a channel defined therebetween is oriented to direct fluid flow into at least one of the plurality of second openings.

3. A method in accordance with claim 2 further comprising coupling the impingement plate to a fluid supply member.

4. A method in accordance with claim 3 further comprising orienting the at least one injection system to enable fluid flow to be discharged into the channel from the fluid supply member through the at least one first opening.

5. A method in accordance with claim 2 further comprising positioning a divider in the channel to facilitate separating air from the fluid flow during turbine engine operation.

6. A method in accordance with claim 1, wherein said coupling the at least one injection system to the at least one cap member further comprises coupling the fluid source to the at least one injection system.

7. A method in accordance with claim 6, wherein said coupling the fluid source to the at least one injection system further comprises coupling at least one of a diluent source and an inert gas source to the at least one injection system.

8. A fuel injection assembly for use in a turbine engine, said fuel injection assembly comprising:
a cap member comprising at least one first opening extending at least partially therethrough and a plurality of second openings extending at least partially therethrough;
a plurality of tube assemblies aligned substantially within said cap member, said plurality of tube assemblies comprising a plurality of tubes; and
at least one injection system comprising a fluid supply member coupled in flow communication between a fluid source and said cap member, said at least one injection system configured to discharge fluid through at least one of said plurality of second openings providing a barrier between adjacent tube assemblies to facilitate reducing dynamic pressure oscillations in a combustor during turbine engine operation.

9. A fuel injection assembly in accordance with claim 8, wherein said cap member further comprises:
an impingement plate, wherein said at least one first opening extends through said impingement plate and is spaced adjacent to at least one of said plurality of tube assemblies; and
an effusion plate, wherein said plurality of second openings extend through said effusion plate and are spaced circumferentially about at least one of said plurality of tube assemblies, said effusion plate is coupled to said impingement plate.

10. A fuel injection assembly in accordance with claim 9, wherein said impingement plate is coupled to said effusion plate such that a channel is defined therebetween, said channel is oriented to direct fluid flow into at least one of said plurality of second openings.

11. A fuel injection assembly in accordance with claim 9, wherein said fluid supply member is coupled to said impingement plate.

12. A fuel injection assembly in accordance with claim 10, wherein said at least one injection system further comprises a divider within said channel for use in separating air from the fluid flow.

13. A fuel injection assembly in accordance with claim 11, wherein said at least one injection system is oriented to enable fluid flow to be discharged into the channel from the fluid supply member through the at least one first opening.

14. A fuel injection assembly in accordance with claim 8, wherein said fluid source comprises at least one of a diluent and an inert gas.

15. A turbine engine, said turbine engine comprising:
a compressor;
a combustion assembly coupled downstream from said compressor; said combustion assembly comprising at least one combustor comprising a fuel injection assembly, said fuel injection assembly comprising a cap member, a plurality of tube assemblies, and at least one injection system, said cap member comprising at least one first opening extending at least partially therethrough and a plurality of second openings extending at least partially therethrough, each tube assembly is aligned substantially within said cap member and comprises a plurality of tubes, said at least one injection system coupled in flow communication to said cap member for discharging fluid through at least one of said plurality of second openings providing a barrier between adjacent tube assemblies to facilitate reducing dynamic pressure oscillations in said combustor during turbine engine operation.

16. A turbine engine in accordance with claim 15, wherein said at least one injection system further comprises a fluid supply member coupled in flow communication between a fluid source and said cap member for discharging fluid through at least one of said plurality of second openings.

17. A turbine engine in accordance with claim 16, wherein said cap member comprises:
an impingement plate, wherein said at least one first opening extends through said impingement plate and is spaced adjacent to at least one of said plurality of tube assemblies; and
an effusion plate, wherein said plurality of second openings extend through said effusion plate and are spaced circumferentially about at least one of said plurality of tube assemblies, said effusion plate is coupled to said impingement plate such that a channel defined therebetween is oriented to direct fluid flow into at least one of said plurality of second openings.

18. A turbine engine in accordance with claim 17, wherein said impingement plate is coupled to said fluid supply member.

19. A turbine engine in accordance with claim 17, wherein said at least one injection system further comprises a divider within said channel for use in separating air from the fluid flow.

20. A turbine engine in accordance with claim 16, wherein said fluid source comprises at least one of a diluent and an inert gas.
